(19) United States
(12) Patent Application Publication
(10) Pub. No.: US 2005/0195719 A1
(43) Pub. Date: Sep. 8, 2005

(54) Optical recording medium tilt compensating device, tilt compensating method, and optical recording device and optical reproducing device utilizing the tilt compensating method

(76) Inventor: Toshiyuki Kawasaki, Kanagawa (JP)

Correspondence Address: DICKSTEIN SHAPIRO MORIN & OSHINSKY LLP, 2101 L Street, NW, Washington, DC, 20037, US

(21) Appl. No.: 11/060,420

(22) Filed: Feb. 17, 2005

(30) Foreign Application Priority Data
Feb. 18, 2004 (JP) 2004-041310
Oct. 20, 2004 (JP) 2004-305422

(51) Int. Cl. G11B 7/00

(52) U.S. Cl. 369/53.19; 369/44.32

(57) ABSTRACT

An optical recording medium tilt compensating device is provided that includes: an objective lens that concentrates light onto a recording surface of an optical recording medium, the light being emitted from a light source; an optical recording medium tilt offset detecting unit that detects a direct current component from a change with time in an optical recording medium tilt caused when the optical recording medium is rotated; and a tilt actuator that controls a tilt of the objective lens by adjusting a relative tilt between the objective lens and the optical recording medium based on the direct current component detected by the optical recording medium tilt offset detecting unit, the relative tilt being obtained from an optical recording medium tilt sensor of an optical pickup that detects the tilt of the optical recording medium.

### BACKGROUND OF THE INVENTION

1. Field of the Invention

The present invention relates to an optical recording medium tilt compensating device that includes a tilt corrector that corrects a tilt error through tilt servo control in a device for performing recording and reproducing on an optical recording medium. The present invention also relates to an optical recording medium tilt compensating method, and an optical recording device and an optical reproducing device that employ the optical recording medium tilt compensating device and method.

2. Description of the Related Art

As a known data recording and reproducing technique, optical beams are used to perform recording and reproducing on a recording medium. A typical example of a system that utilizes the optical recording technique is the DVD system that is currently on the market. The DVD system was developed in response to a demand that two hours of MPEG2 compressed image information be recorded on one side of an optical recording medium of 12 cm in diameter. By the DVD standard, the memory capacity of one side of a disc is 4.7 GB, the track density is 0.74 μm/track, and the linear density is 0.267 μm/bit. Hereinafter, the DVDs in compliance with the standard are referred to as the present DVDs.

Information that is recorded on an optical recording medium such as a DVD is reproduced using an optical head. At the optical head, optical beams emitted from a laser diode are concentrated onto a pit line on the track of the optical recording medium through an objective lens. The optical beams reflected by the optical recording medium are concentrated onto a photodetector through a condenser lens, thereby obtaining a reproduction signal. The reproduction signal from the photodetector is input to a reproduction signal processing system, and data decoding is performed. In accordance with the DVD standard, the wavelength of the laser diode of the optical head is 650 nm, and the numerical aperture (NA) of the objective lens is 0.6.

Further, as a high-density DVD standard, Blu-ray Disc has been developed. More specifically, Blu-ray Disc is the standard of the video recorders for the next-generation, large-capacity optical recording media. In accordance with the standard, using a blue-violet laser of 405 nm in wavelength, maximum image data of 27 GB can be repeatedly recorded on and reproduced from a phase-variable optical recording medium of 12 cm in diameter, which is the same as the diameter of a CD or a DVD. While a short-wavelength blue-violet laser is used, the numerical aperture (NA) of the objective lens that condenses laser beams is set 0.85, thereby minimizing the size of each beam spot.

To accommodate the high numerical aperture of the objective lens, an optical recording medium structure with a light transmission protection layer of 0.1 mm in thickness is employed to reduce the aberration cased by the tilt of the optical recording medium, reduce the read error, and increase the recording density. Therefore, the recording track pitch of the optical recording medium is narrowed to 0.32 μm, which is substantially a half of the track pitch on a DVD. Thus, high-density recording of 27 GB at the maximum on one side of an optical recording medium is realized.

FIG. 9 is a schematic view of a DVD optical pickup that can perform a writing operation. In a case where a DVD optical pickup can perform a writing operation, a polarization optical system is employed to increase the illumination efficiency. More specifically, a polarizing beam splitter (hereinafter referred to as PBS) 3 is provided in the optical path extending from a light-source laser diode (hereinafter referred to as LD) 1 to an objective lens (hereinafter referred to as OL) 2. Light of the same polarization plane as the linearly polarized light of the LD 1 is transmitted through the PBS 3, and is then turned into circularly polarized light by a ¼ wavelength plate 4. The light is then condensed by the OL 2, and is incident upon the recording layer below the substrate of an optical recording medium (hereinafter referred to as the optical disc) 5. The light reflected from the reflection surface of the optical disc 5 is circularly polarized light with the rotation reverse to the incident light. After transmitted through the ¼ wavelength plate 4, the reflected light becomes linearly polarized light with a polarization plane lying in a direction perpendicular to the polarization plane of the LD 1. The linearly polarized light is then reflected by the PBS 3, and introduced into a photodetector (hereinafter referred to as PD) 6. If the light is turned into complete circular light by the ¼ wavelength plate 4, the transmission light of the PBS 3, which is the return light of the LD 1, exhibits “0”, and the reflected light from the light disc 5 is thoroughly detected by the PD 6.

The optical pickup scans minute recording marks on the optical disc 5 with the optical beam condensed by the OL 2, and reproduces the recorded information. At this point, the information recording surface might tilt with respect to the optical beam emitted from the optical pickup, because of a bend or a curve of the optical disc 5. In such a case, the optical beam to reproduce the information recorded on the optical disc 5 is incident upon the information recording surface in a tilting state, and a frame aberration is caused in the spot diameter of the optical beam on the information recording surface. As a result, the spot becomes asymmetrical in shape, and an accurate recording information reading operation becomes difficult. If the numerical aperture (NA) of the OL 2 is reduced so as to reduce the spot diameter especially for a capacity as large as a Blu-ray disc, the frame aberration with respect to the tilt of the optical disc 5 becomes larger, and the margin for the tilt of the optical disc 5 decreases. Therefore, so as to obtain a larger capacity, it is necessary to employ a function for compensating for the tilt of the optical disc 5.

Japanese Laid-Open Patent Application No. 2002-260264 discloses a technique of compensating for a tilt with a 4-axis actuator (hereinafter referred to as ACT). As shown in FIG. 10, the OL 2 is normally arranged in parallel with the optical disc 5, and is supported by the wire of a 4-axis ACT 7. When focusing is performed on the recording surface of the optical disc 5 and the shape of the spot is observed, a circular spot is obtained as shown in a part of the optical disc 5 in the upper half of FIG. 10. However, when a tilt is caused in the optical disc 5 as shown in FIG. 11, the spot shape becomes ellipsoidal as shown in the optical disc 5 in the upper half of FIG. 11. Further, a frame aberration is caused, which hinders concentration of irradiation rays.

To counter this problem, the OL 2 is tilted by the 4-axis ACT 7, so that the OL 2 becomes parallel with the optical disc 5, as shown in FIG. 12. In this manner, the spot shape becomes circular again, as indicated in a part of the optical disc 5 shown in the upper half of FIG. 12. Thus, the tilt of the optical disc 5 can be compensated for. The 4-axis ACT 7 can control a radial tilt and a tangential tilt, as well as focusing and tracking that are conventionally performed by ACTs.

Referring now to FIG. 13, the tilt compensating system is described in greater detail. An OL tilt sensor 10 for detecting a tilt of the OL 2 is provided under the OL 2. The OL tilt sensor 10 detects a tilt of the OL 2, and converts the tilt into an electric signal. Also, an optical disc tilt sensor 13 for detecting a tilt is provided under the optical disc 5. For example, a tilt of the optical disc 5 can be detected, because the light-source beam emitted from the LD is reflected by the optical disc 5 and is detected by a double-divided PD, and the quantities of light detected by the double-divided PD are varied when the optical disc 5 tilts. The difference between the output signals of the two tilt sensors is detected and is then input to an OLACT (objective lens actuator) driver 14 via a compensator 9. The OLACT driver 14 drives the OLACT 8 in accordance with the difference signal of the tilt sensors.

Next, the operation of this system is described. When an optical disc is inserted, a first SW 11 is connected to a servo lead-in circuit 15, and a second SW 12 is turned off. A servo lead-in is performed by the servo lead-in circuit 15. When the tilt of the OL 2 is “0”, the first SW 11 is connected to the compensator 9 so as to form a closed loop and drive the OL tilt servo. The second SW 12 is then connected, so that the OL tilt amount varies with the signal representing the optical disc tilt amount that is output from the optical disc tilt sensor 13.

In a case where the optical axis of the optical beam is not perpendicular to the recording surface of the optical disc when the objective lens of the 4-axis ACT is in the initial position, or in a case where the tilt servo is driven when the quantity of light reflected by the optical disc is small during a focus control operation, the tilt error signal becomes variable, and the objective lens is shifted, resulting in poor focus servo control. To counter this problem, Japanese Laid-Open Patent Application No. 2003-016677 discloses a technique of performing a stable OL tilt control operation. The optical tilt control operation through OL tilt control using a 4-axis ACT is performed in conformity with the curve or bend of the optical disc. Therefore, tilt control is performed so that the optical axis of the optical beam is made perpendicular to the plane of the optical disc.

Japanese Laid-Open Patent Application No. 2000-187866 discloses a tilt servo driving method. More specifically, in accordance with the output of a lens tilt sensor, lens tilt servo is first performed. Relative tilt servo is then performed by a lens/disc relative tilt sensor. Japanese Laid-Open Patent Application No. 2000-276756 also discloses a tilt servo driving method. By this method, prior to a tilt servo lead-in, the focus driving unit of a lens actuator performs driving so that the objective lens holder is positioned substantially in the center in the focusing direction.

With the tilt compensating system utilizing a 4-axis ACT disclosed in Japanese Laid-Open Patent Application Nos. 2002-260264 and 2003-016677, a tilt of the optical disc is detected, and the OL is tilted in accordance with the detected tilt. As shown in FIG. 13, the OL tilt sensor 10 is the only sensor provided in the closed loop of the OL tilt servo, and open-loop control, instead of closed-loop control, is performed on the optical disc tilt sensor 13. Accordingly, if there is an offset between the optical disc tilt sensor 13 and the OL tilt sensor 10, the relative offset is regarded as a control error. Where the maximum value of the tilt of the optical disc 5 to be corrected is 0.1 deg and the closed-loop gain of the OL tilt servo is 40 dB, the control error caused in the servo system is 0.8×10−5 rad. Although the control error caused in the servo system is small enough, the offset between the tilt sensors is large. The large offset between the tilt sensors is a problem that should be urgently solved in the radial, tangential tilt compensating system.

In a case where a large-capacity optical disc such as an AOD (Advanced Optical Disc) is employed, a frame aberration is especially large with respect to the tilt of the optical disc. This tendency is particularly conspicuous, when the substrate thickness is set 0.6 mm, which is longer than the wavelength, to give DVD compatibility to the optical disc. In such a case, the margin with respect to the tilt of the optical disc is particularly restricted. Therefore, for the next-generation discs with large capacity and high density, a function of compensating for an optical disc tilt is essential.

Such large-capacity optical discs are not developed with a single wavelength, and the compatibility with the already available CD and DVD drives is important. In the case of a pickup that has compatibility with three wavelengths including CD and DVD, the optical axes of the respective wavelengths cannot be made perfectly parallel to one another. Even if the tilt offset of one wavelength is adjusted to “0”, an offset cannot be avoided with the other wavelengths. If the tilt compensating system is operated when there is an offset, the optical disc tilt correcting effect becomes small. In some cases, even the spot shape deteriorates.

By the tilt servo lead-in methods disclosed in Japanese Laid-Open Patent Application Nos. 2000-187866 and 2000-276756, lead-in procedures are specifically defined, but a technique of preventing an offset in the control loop is not defined.

### SUMMARY OF THE INVENTION

A general object of the present invention is to provide an optical disc tilt compensating device and method in which the above disadvantages are eliminated.

A more specific object of the present invention is to provide an optical disc tilt compensating device and method that cancel an offset between tilt sensors so as to minimize the frame aberration caused due to an error in the tilt amount of the optical disc.

Another specific object of the present invention is to provide an optical pickup that utilizes the tilt compensating device and method to eliminate the above disadvantages with the prior art.

Yet another specific object of the present invention is to provide an optical disc tilt compensating device and method that employ the optical pickup to perform information recording and reproducing operations.

Still another specific object of the present invention is to provide an optical recording device and an optical reproducing device that utilize the optical disc tilt compensating method.

The above objects of the present invention are achieved by an optical recording medium tilt compensating device that includes: an objective lens that condenses light onto a recording surface of an optical recording medium, the light being emitted from a light source; an optical recording medium tilt offset detecting unit that detects a direct current component from a change with time in an optical recording medium tilt caused when the optical recording medium is rotated; and a tilt actuator that controls a tilt of the objective lens by adjusting a relative tilt between the objective lens and the optical recording medium based on the direct current component detected by the optical recording medium tilt offset detecting unit, the relative tilt being obtained from an optical recording medium tilt sensor of an optical pickup that detects the tilt of the optical recording medium.

The above objects of the present invention are also achieved by an optical recording medium tilt compensating device that includes: an objective lens that condenses light onto a recording surface of an optical recording medium, the light being emitted from a light source; an objective lens tilt sensor that detects a tilt of the objective lens; an optical recording medium tilt sensor that detects a tilt of the optical recording medium; a relative tilt detecting unit that detects a relative tilt between the objective lens and the optical recording medium from the tilts detected by the objective lens tilt sensor and the optical recording medium tilt sensor; an optical recording medium tilt offset detecting unit that detects a direct current component from a change with time in the tilt of the optical recording medium, the change with time being caused when the optical recording medium is rotated; and an objective lens tilt actuator that controls the tilt of the objective lens by adjusting the relative tilt based on the direct current component detected by the optical recording medium tilt offset detecting unit.

The above objects of the present invention are also achieved by an optical recording medium tilt compensating device that includes: an objective lens that condenses light onto a recording surface of an optical recording medium, the light being emitted from a light source; an objective lens tilt actuator that controls a tilt of the objective lens; an objective lens tilt sensor that detects the tilt of the objective lens; an optical recording medium tilt sensor that detects a tilt of the optical recording medium; an arithmetic operation unit that calculates a relative tilt between the objective lens and the optical recording medium from the tilt detected by the objective lens tilt sensor and the tilt detected by the optical recording medium tilt sensor; a control unit that controls the tilt of the objective lens in such a manner that the aberration of the diameter of a spot formed by concentrating the light onto the recording surface of the optical recording medium is minimized, the control being performed by driving the objective lens tilt actuator, based on the relative tilt output from the arithmetic operation unit; and an optical recording medium tilt offset detecting unit that detects a direct current component from a change with time in the tilt of the optical recording medium, the change with time being caused when the optical recording medium is rotated. In this optical recording medium tilt compensating device, the relative tilt is adjusted based on the detected direct current component.

The above objects of the present invention are also achieved by an optical recording medium tilt compensating device that includes: an objective lens that condenses light onto a recording surface of an optical recording medium, the light being emitted from a light source; an objective lens tilt actuator that controls a tilt of the objective lens; an objective lens tilt sensor that detects the tilt of the objective lens; an optical recording medium tilt sensor that detects a tilt of the optical recording medium; an arithmetic operation unit that calculates a relative tilt between the objective lens and the optical recording medium from the tilt detected by the objective lens tilt sensor and the tilt detected by the optical recording medium tilt sensor; a control unit that controls the tilt of the objective lens in such a manner that the aberration of the diameter of a spot formed by concentrating the light onto the recording surface of the optical recording medium is minimized, the control being performed by driving the objective lens tilt actuator, based on the relative tilt output from the arithmetic operation unit; and an extracting unit that separates and extracts a direct current component from the tilt of the optical recording medium, based on a change with time in the tilt of the optical recording medium that is output from the optical recording medium tilt sensor, the change with time being caused when the optical recording medium is rotated. In this optical recording medium tilt compensating device, the relative tilt is adjusted based on the separated and extracted direct current component.

In the above optical recording medium tilt compensating device, the extracting unit that separates and extracts the direct current component from the tilt of the optical recording medium may be an integrator that integrates the output signal from the optical recording medium tilt sensor in accordance with the rotation cycles of the optical recording medium. The integrator has an integration time constant that is log (1−P) times as great as one rotation cycle of the optical recording medium, with P representing the reliability of the output signal. Alternatively, the integrator may have an integration time constant that is equivalent to three rotation cycles of the optical recording medium.

In the above optical recording medium tilt compensating device, the extracting unit that separates and extracts the direct current component from the tilt of the optical recording medium may be a low pass filter that is inserted in a stage after the signal output terminal of the optical recording medium tilt sensor.

The above objects of the present invention are also achieved by an optical recording medium tilt compensating device that includes: an objective lens that condenses light onto a recording surface of an optical recording medium, the light being emitted from a light source; an objective lens tilt actuator that controls a tilt of the objective lens; an objective lens tilt sensor that detects the tilt of the objective lens; an optical recording medium tilt sensor that detects a tilt of the optical recording medium; an arithmetic operation unit that calculates a relative tilt between the objective lens and the optical recording medium from the tilt detected by the objective lens tilt sensor and the tilt detected by the optical recording medium tilt sensor; a control unit that controls the tilt of the objective lens in such a manner that the aberration of the diameter of a spot formed by concentrating the light onto the recording surface of the optical recording medium is minimized, the control being performed by driving the objective lens tilt actuator, based on the relative tilt output from the arithmetic operation unit; and an offset adjusting unit that electrically adjusts a direct current component in the tilt output from the optical recording medium tilt sensor.

The optical recording medium tilt compensating device may further include an extracting unit that separates and extracts the direct current component from the tilt of the optical recording medium that is output from the optical recording medium tilt sensor, based on a change with time in the tilt of the optical recording medium, the change with time being caused when the optical recording medium is rotated. In the optical recording medium tilt compensating device, a low pass filter may be inserted in a stage before the offset adjusting unit that electrically adjusts the direct current component in the tilt that is output from the optical recording medium tilt sensor.

In the optical recording medium tilt compensating device, the low pass filter may have a time constant that is log(1−P) times as great as one rotation cycle of the optical recording medium, with P representing the reliability of the output signal. 13. Alternatively, the low pass filter may have a time constant that is equivalent to three rotation cycles of the optical recording medium. Alternatively, the low pass filter may have a time constant τ that satisfies the following condition:

$$τ > \frac{6 π r}{v} \qquad ( 1 )$$

where r represents the radius location of the diameter of the spot formed on the optical recording medium, and v represents the linear velocity.

In the optical recording medium tilt compensating device, the time constant of the low pass filter may be 182 ms.

In the optical recording medium tilt compensating device, the offset adjusting unit may electrically adjust the direct current component in a signal representing the tilt output from the optical recording medium tilt sensor, and output the signal representing the optical recording medium tilt with the direct current component of “0”. The optical recording medium tilt compensating device may further include a storage unit that stores the value of the direct current component separated and extracted from the optical recording medium tilt by the direct current component separating and extracting unit, when an optical pickup or a drive is installed. Further, in the optical recording medium tilt compensating device, the offset adjusting unit that electrically adjusts the direct current component in the signal representing the tilt output from the optical recording medium tilt sensor is constantly in the electrically adjusting state while the optical recording medium is in a drive, so that the direct current component of the optical recording tilt to be output from the offset adjusting unit becomes “0”.

The above objects of the present invention are also achieved by an optical recording medium tilt compensating method that includes the steps of: detecting a tilt of an optical recording medium by an optical recording medium tilt sensor; detecting a direct current component of the optical recording medium tilt that is caused when the optical recording medium is rotated; calculating a relative tilt from an objective lens tilt detected by an objective lens tilt sensor and the optical recording medium tilt, using an arithmetic operation unit; and controlling the tilt of the objective lens by adjusting the relative tilt based on the detected direct current component.

In the above optical recording medium tilt compensating method, the direct current component of the optical recording medium tilt that is caused by the rotation of the optical recording medium may be separated and extracted by an integrator that integrates the tilt output from the optical recording medium tilt sensor in accordance with rotation cycles of the optical recording medium. The integrator may integrate the output signal from the optical recording medium tilt sensor, using an integration time constant that is log (1−P) times as great as one rotation cycle of the optical recording medium, with P representing the reliability of the output signal. Alternatively, the integrator may integrate the output signal from the optical recording medium tilt sensor, using an integration time constant that is equivalent to three rotation cycles of the optical recording medium.

In the above optical recording medium tilt compensating method, the direct current component of the optical recording medium tilt that is caused by the rotation of the optical recording medium may be separated and extracted by a low pass filter that is inserted in a stage after the signal output terminal of the optical recording medium tilt sensor. The low pass filter may separate and extract the direct current component of the output signal from the optical recording medium tilt sensor, using a time constant that is log(1−P) as great as one rotation cycle of the optical recording medium, with P representing the reliability of the output signal. Alternatively, the low pass filter may separate and extract the direct current component of the output signal from the optical recording medium tilt sensor, using a time constant that is equivalent to three rotation cycles of the optical recording medium. Further, the low pass filter may separate and extract the direct current component of the output signal from the optical recording medium tilt sensor, using a time constant τ that satisfies the following condition:

$$τ > \frac{6 π r}{v} \qquad ( 2 )$$

where r represents the radius location of the diameter of the spot formed on the optical recording medium, and v represents the linear velocity. The low pass filter may also separate and extract the direct current component of the output signal from the optical recording medium tilt sensor, using a time constant of 182 ms.

In the above optical recording medium tilt compensating method, the electric adjustment may be performed using the direct current component, so that the direct current component of the optical recording medium tilt caused by the rotation of the optical recording medium becomes “0”. In the optical recording medium tilt compensating method, the direct current component of the optical recording medium tilt caused by the rotation of the optical recording medium may be separated and extracted when an optical pickup or a drive is installed, and the value of the direct current component may be stored in a storage unit. Further, the adjustment to be performed using the direct current component in such a manner that the direct current component of the optical recording medium tilt becomes “0” may be constantly performed while the optical recording medium is in a drive.

The above objects of the present invention are also achieved by an optical recording device that includes one of the above described optical recording medium tilt compensating device or utilizes one of the above described optical recording medium tilt compensating methods. This optical recording device characteristically adjusts a direct current component of the optical recording medium tilt, and performs information recording or erasing by concentrating the light onto the recording surface of the optical recording medium.

The above objects of the present invention are also achieved by an optical reproducing device that includes one of the above described optical recording medium tilt compensating devices or utilizes one of the above described optical recording medium tilt compensating method. This optical reproducing device adjusts a direct current component of the optical recording medium tilt, and performs information reproduction by detecting transmission light or reflected light from the optical recording medium with a photodetector, or detecting the light condensed in the signal detecting optical system, after concentrating the light onto the recording surface of the optical recording medium.

With the optical recording medium tilt compensating device, the tilt compensating method, the optical recording device, and the optical reproducing device in accordance with the present invention, the tilt control error caused due to the offset error in the optical disc tilt can be dramatically reduced, and an optical recording medium tilt compensating device and method with a high-precision objective lens tilt servo can be realized. Also, frame aberrations can be minimized, and a high-quality beam spot can be formed on the optical disc. Thus, an optical pickup with less read errors and higher writing quality can be obtained, and information recording and reproducing can be performed with the optical pickup.

As described so far, in accordance with the present invention, the tilt control error caused by the offset error in the signal representing the optical disc tilt can be dramatically reduced, and an optical disc tilt compensating device and method utilizing a high-precision OL tilt servo can be realized. Accordingly, a high-quality beam spot with minimized frame aberrations can be formed on the surface of the optical disc. Thus, an optical pickup with less read errors and higher writing quality can be obtained, and an optical recording and reproducing device that performs information recording and reproducing with the optical pickup can be realized.

The above and other objects, features, and advantages of the present invention will become more apparent from the following detailed description taken in conjunction with the accompanying drawings.

### BRIEF DESCRIPTION OF THE DRAWINGS

FIG. 1 is a schematic view of a tilt compensating device in accordance with a first embodiment of the present invention;

FIG. 2 illustrates the principle that the tangential tilt offset of the optical disc is “0”;

FIG. 3 is a schematic view of a tilt compensating device in accordance with a second embodiment of the present invention;

FIG. 4 is a schematic view of a tilt compensating device that employs a HPF in accordance with the second embodiment;

FIG. 5 is a schematic view of a tilt compensating device that employs a differentiator in accordance with the second embodiment;

FIG. 6 is a schematic view of a tilt compensating device in accordance with a third embodiment of the present invention;

FIG. 7 is a schematic view of a tilt compensating device in accordance with a fourth embodiment of the present invention;

FIG. 8 is a schematic perspective view of an optical recording and reproducing device in accordance with a fifth embodiment of the present invention;

FIG. 9 is a schematic view of a conventional optical pickup;

FIG. 10 illustrates the arrangement of an OL and a 4-axis ACT that perform conventional tilt driving, and the diameter of a spot formed on the optical disc in the normal state;

FIG. 11 illustrates the arrangement of the OL and the 4-axis ACT that perform conventional tilt driving, and the diameter of the spot formed on the optical disc in an abnormal state;

FIG. 12 illustrates the arrangement of the OL and the 4-axis ACT that perform conventional tilt driving, and the diameter of the spot formed on the optical disc in a compensating operation; and

FIG. 13 is a schematic view of a conventional tilt compensating device.

### DESCRIPTION OF THE PREFERRED EMBODIMENTS

The following is a description of embodiments of the present invention, with reference to the accompanying drawings.

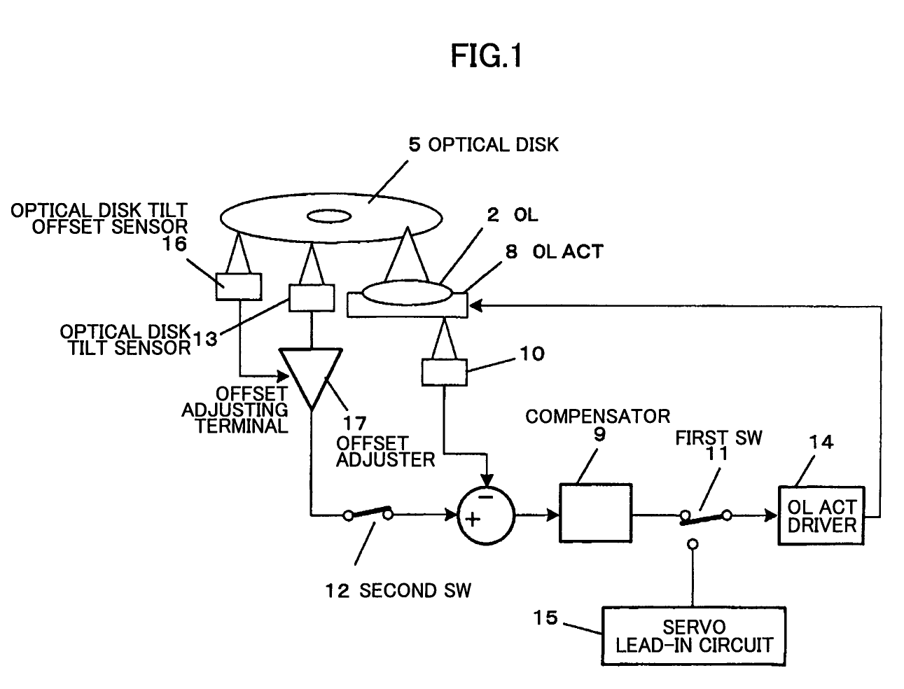

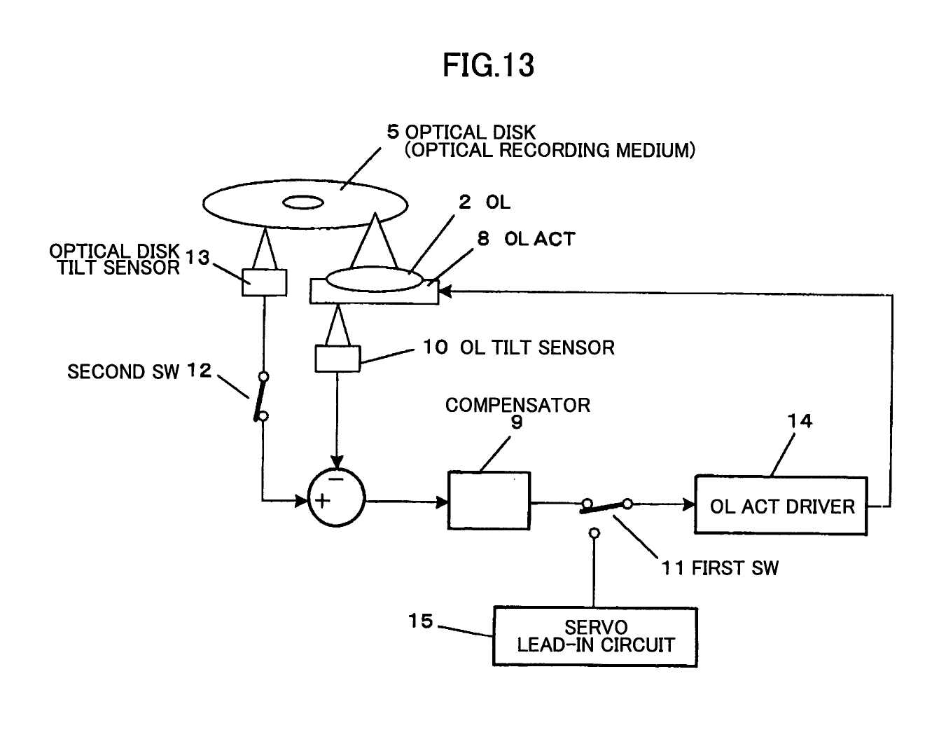

FIG. 1 schematically illustrates a tilt compensating device in accordance with a first embodiment of the present invention. Here, the same components and functions as those of the conventional structure shown in FIG. 13 are denoted by the same reference numerals as those in FIG. 13.

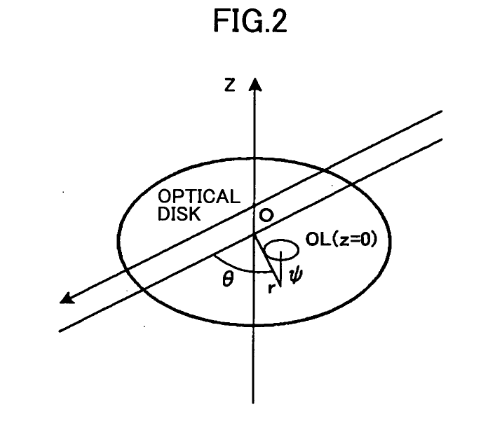

First, the principle that the tangential tilt offset of an optical disc is “0” is described. Referring to FIG. 2 illustrating the positional relationship between the optical disc and an OL, the radial tilt φ r and the tangential tilt φθ of the optical disc are determined.

The OL is placed on the r, θ reference plane (Z=0), and the level of the optical disc that is determined by the location (the level) of the OL when focusing is performed on the optical disc is denoted by φ. Here, φ is the function of the radius r and the tangential-direction angle θ, which can be expressed as (r, θ) and is a two-dimensional scalar function (a curved plane).

Also, gradφ is a two-dimensional vector that represents the tilt of the curved plane φ(r, θ), and can be expressed as follows, using a Hamilton operator ∇:
gradφ(r, θ)=∇φ (3)

Here, ∇ is expressed as follows, using unit vectors er and eθ:

$$∇ = \frac{\partial }{\partial r} {e}_{r} + \frac{1}{r} \times \frac{\partial }{\partial θ} {e}_{θ} \qquad ( 4 )$$

Expression (4) is substituted in Expression (3) to obtain Expression (5):

$$grad ϕ ( r , θ ) = ( \frac{\partial }{\partial r} {e}_{r} + \frac{1}{r} \times \frac{\partial }{\partial θ} {e}_{θ} ) ϕ = \frac{\partial ϕ}{\partial r} {e}_{r} + \frac{1}{r} \times \frac{\partial ϕ}{\partial θ} {e}_{θ} \qquad ( 5 )$$

Here, the coefficient of the unit vector er is expressed as:

$$\frac{\partial ϕ ( r , θ )}{\partial r} \qquad ( 6 )$$

The coefficient of the unit vector er represents the tilt in the radial direction. Meanwhile, the coefficient of the unit vector eθ is expressed as follows:

$$\frac{1}{r} \times \frac{\partial ϕ ( r , θ )}{\partial θ} \qquad ( 7 )$$

The coefficient of the unit vector eθ represents the tilt in the tangential direction. The arc tangents of those coefficients are obtained to determine the radial and tangential tilts φr(r) and φθ(θ), which are expressed in terms of angles as follows:

$$\begin{matrix}{ϕ}_{r} ( r ) = {tan}^{- 1} ( \frac{\partial ϕ ( r , θ )}{\partial r} & ( 8 ) \\ {ϕ}_{θ} ( θ ) = {tan}^{- 1} ( \frac{1}{r} \times \frac{\partial ϕ ( r , θ )}{\partial θ} ) & ( 9 )\end{matrix}$$

Expressions (8) and (9) are integrated in the track direction, so as to obtain the radial tilt offset and the tangential tilt offset of the optical disc.

Here, in the case of the tangential tilt offset of Expression (9), one-round integration is performed along the unit vector eθ. Since the starting point and the finishing point of the round integration are the same, the integration result is “0”. Accordingly, the tangential tilt offset of the optical disc is “0”.

Referring back to FIG. 1, the principle that the offset of the tilt sensors is canceled is described based on the fact that the tangential tilt offset of the optical disc is “0” in the first embodiment. In the optical disc tilt compensating device shown in FIG. 1, an OL tilt sensor 10 for detecting the tilt of an OL 2 is placed under the OL 2. The OL tilt sensor 10 detects the tilt of the OL 2, and converts the tilt into an electric signal. Meanwhile, an optical disc tilt sensor 13 that detects the tilt of an optical disc 5 is placed under the optical disc 5. The difference between the output signals of the two tilt sensors is input to an OLACT driver 14 via a compensator 9. The OLACT driver 14 drives an OLACT 8 in accordance with the difference signal of the two tilt sensors. On the side of the optical disc 5, an optical disc tilt offset sensor 16 for detecting the tilt offset of the optical disc 5 is also provided. An offset adjuster 17 is inserted to the output of the optical disc tilt sensor 13, and the output of the optical disc tilt offset sensor 16 is connected to the offset adjusting terminal of the offset adjuster 17, so as to adjust the offset of the optical disc tilt sensor 13.

In a case where the optical disc tilt sensor 13 that detects the tilt of the optical disc 5 is attached to the optical pickup and the optical pickup is tilted to tilt the OL 2, the relative tilts of the optical disc 5 and the OL 2 can be directly determined by the optical disc tilt sensor 13. Accordingly, the tilt actuator is driven based on the tilts. Further, the tilts and the output of the optical disc tilt offset sensor 16 are supplied to the offset adjuster 17 to adjust the offset of the optical disc tilt sensor 13.

Next, the operation of the tilt compensating device in accordance with the first embodiment is described. In the initial state, a first SW 11 is connected to a servo lead-in circuit 15, and a second SW 12 is turned off. When the optical disc 5 is inserted into a drive (not shown) and is rotated by a spindle motor, a signal representing the optical disc tilt is output from the optical disc tilt sensor 13. At the same time, a signal representing the tilt offset of the optical disc 5 is output from the optical disc tilt offset sensor 16. According to the above described round integration (Expression 9), the tangential tilt offset of the optical disc 5 is “0”. Therefore, the output of the optical disc tilt offset sensor 16 is the tilt offset components of the direct current (DC) generated in the optical disc tilt sensor 13 and the entire tilt compensating device. Using the signal, the offset adjuster 17 cancels the offset of the signal representing the optical disc tilt.

More specifically, the signal representing the optical disc tilt offset is subtracted from the signal representing the optical disc tilt. The optical disc tilt signal that has been subjected to the offset adjustment represents a tilt offset of “0” in the case of a tilt sensor in the tangential direction.

At the time of a servo lead-in, the servo lead-in circuit 15 performs a servo lead-in operation. When the OL tilt is “0”, the first SW 11 is connected to the compensator 9 to form a closed loop and drive the OL tilt servo. The second SW 12 is then connected, so that the optical disc tilt signal output from the optical disc tilt sensor 13 varies with the OL tilt. The offset adjustment on the side of the OL tilt sensor 10 is performed using a detection signal such as a signal-quality evaluation signal when the RF signal becomes the greatest or “Jitter” becomes the smallest.

In this manner, the tilt control error caused due to the offset error of the optical disc tilt signal can be dramatically reduced, and an optical disc tilt compensating device with high-precision OL tilt servo can be realized.

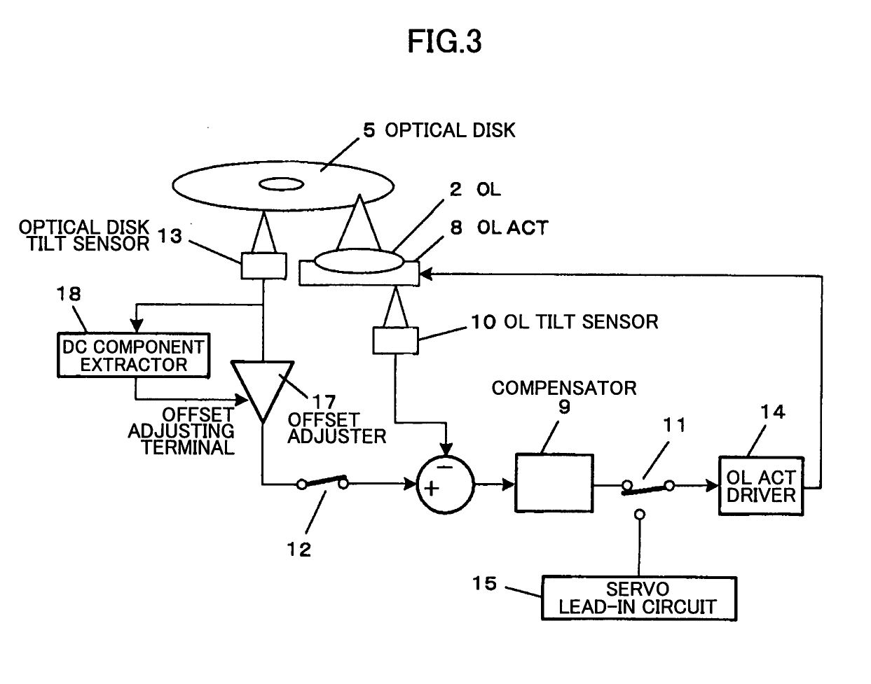

FIG. 3 is a schematic view of a tilt compensating device in accordance with a second embodiment of the present invention. In the optical disc tilt compensating device shown in FIG. 3, an OL tilt sensor 10 for detecting the tilt of an OL 2 is placed under the OL 2. The OL tilt sensor 10 detects the tilt of the OL 2, and converts the tilt into an electric signal. Meanwhile, an optical disc tilt sensor 13 that detects the tilt of an optical disc 5 is placed under the optical disc 5. The difference between the output signals of the two tilt sensors is input to an OLACT driver 14 via a compensator 9. The OLACT driver 14 drives an OLACT 8 in accordance with the difference signal of the two tilt sensors. At the output of the optical disc tilt sensor 13, a DC component extractor 18 is provided. The DC component extractor 18 extracts the direct current (DC) components of the tilt offset of the optical disc 5 from the output of the optical disc tilt sensor 13. An offset adjuster 17 is inserted to the output of the optical disc tilt sensor 13, and the output of the DC component extractor 18 is connected to the offset adjusting terminal of the offset adjuster 17, so as to adjust the offset of the optical disc tilt sensor 13.

Next, the operation of the tilt compensating device in accordance with the second embodiment is described. In the initial state, a first SW 11 is connected to a servo lead-in circuit 15, and a second SW 12 is turned off. When the optical disc 5 is inserted into a drive (not shown) and is rotated by a spindle motor, a signal representing the optical disc tilt is output from the optical disc tilt sensor 13. At the same time, a signal representing the optical disc tilt offset (a DC component) is separated and extracted from the signal representing the optical disc tilt. According to the above described round integration (Expression 9), the tangential tilt offset (the DC component) of the optical disc 5 is “0”. Accordingly, the signal representing the optical disc tilt offset is the tilt offset component (the DC component) generated in the optical disc tilt sensor 13 and the entire tilt compensating device.

Using the signal, the offset adjuster 17 cancels the offset of the signal representing the optical disc tilt. More specifically, the signal representing the optical disc tilt offset is subtracted from the signal representing the optical disc tilt. The optical disc tilt signal that has been subjected to the offset adjustment represents a tilt offset of “0” in the case of a tilt sensor in the tangential direction.

At the time of a servo lead-in, the servo lead-in circuit 15 performs a servo lead-in operation. When the OL tilt is “0”, the first SW 11 is connected to the compensator 9 to form a closed loop and drive the OL tilt servo. The second SW 12 is then connected, so that the optical disc tilt signal output from the optical disc tilt sensor 13 varies with the OL tilt. The offset adjustment on the side of the OL tilt sensor 10 is performed using a detection signal such as a signal-quality evaluation signal when the RF signal becomes the greatest or “Jitter” becomes the smallest.

In another example of the second embodiment, the DC component extractor 18 in the optical disc tilt compensating device shown in FIG. 3 is a low pass filter (not shown). The DC component of the optical disc tilt signal are extracted through the low pass filter, and are input to the offset adjuster 17. The offset adjuster 17 subtracts the tilt offset from the optical disc tilt signal, and then outputs an optical disc tilt signal that is offset free and DC free.

The time constant of the low pass filter is set greater than the value equivalent to three rotation cycles of the optical disc 5. The step response of the low pass filter is expressed as follows:
V₂(t)=V₀(1−e^{-t/τ}) (10)
(t: time, V₂: output signal, V₀: output value in the case of t→∞, τ: time constant)

Here, with t being equal to τ, the output signal V₂ is V₂(τ)=0.63 V₀. When the output signal V₂ is 0.95 V₀, the time is expressed as follows:
t=−τlog (1−V₂/ V₀) (11)

As V₂=0.95 V₀ is substituted in Expression (11), the time is t=3τ.

More specifically, during the step response, the output signal V₂ reaches 95% of the output value V₀ in a period of time that is three times as longer than the time constant τ, with t being equal to τ. Accordingly, where the time constant τof the low pass filter is set three times as great as one rotation cycle, the DC component can be detected and removed, without an adverse influence on the tilt signal of the rotation cycle of the optical disc 5.

For example, where the linear velocity is 6 m/s, one rotation cycle is 60.7 ms, with the outermost radius being 58 mm. In such a case, the time constant of the low pass filter is 182 ms, which is substantially three times as great as one rotation cycle. With the low pass filter having the time constant of 182 ms, the amplitude of one rotation cycle is −0.46 dB, and the phase difference is 19 deg. Through the low pass filter having the time constant that is three times as great as one rotation cycle, the DC component in the tilt signal can be removed, without an adverse influence on the DC component in the optical disc tilt at higher frequencies than the rotation frequency. In short, so as to detect and remove the DC component without an adverse influence on the tilt signal of the rotation cycles, it is necessary to make the time constant of the low pass filter three times as great as one rotation cycle.

Also, where r represents the radius location of the diameter of a spot formed on the optical disc 5, and v represents the linear velocity, the time constant τ of the low pass filter may take a value that satisfies the following expression:

$$τ > \frac{6 π r}{v} \qquad ( 12 )$$

The right side of Expression (12) represents a value that is obtained by dividing the circumference 2πr at the radius location r by the linear velocity v, which is a value that is obtained by multiplying one rotation cycle by 3. Expression (12) expresses that the time constant τ of the low pass filter should be greater than this value. Through the low pass filter having a time constant three times as great as one rotation cycle, the DC component in the tilt signal can be removed, without an adverse influence on the optical disc tilt components at higher frequencies than the rotation frequency. So as to detect and remove the DC component without an adverse influence on the tilt signal of the rotation cycle, the time constant of the low pass filter should satisfy Expression (12).

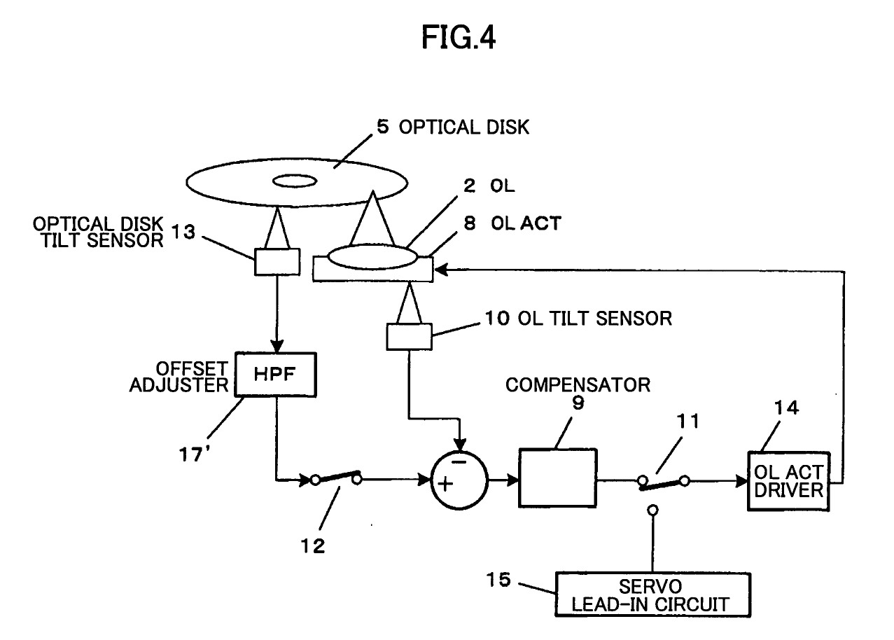

In place of the offset adjuster 17 shown in FIG. 3, a high pass filter (HPF) 17′ may be employed as shown in FIG. 4. The time constant of the high pass filter 17′ should also be at least three times as great as one rotation cycle. More specifically, where the linear velocity is 6 m/s, one rotation cycle is 60.7 ms, with the outermost radius being 58 mm. In that case, the time constant of the high pass filter 17′ is 182 ms, which is three times as great as one rotation cycle.

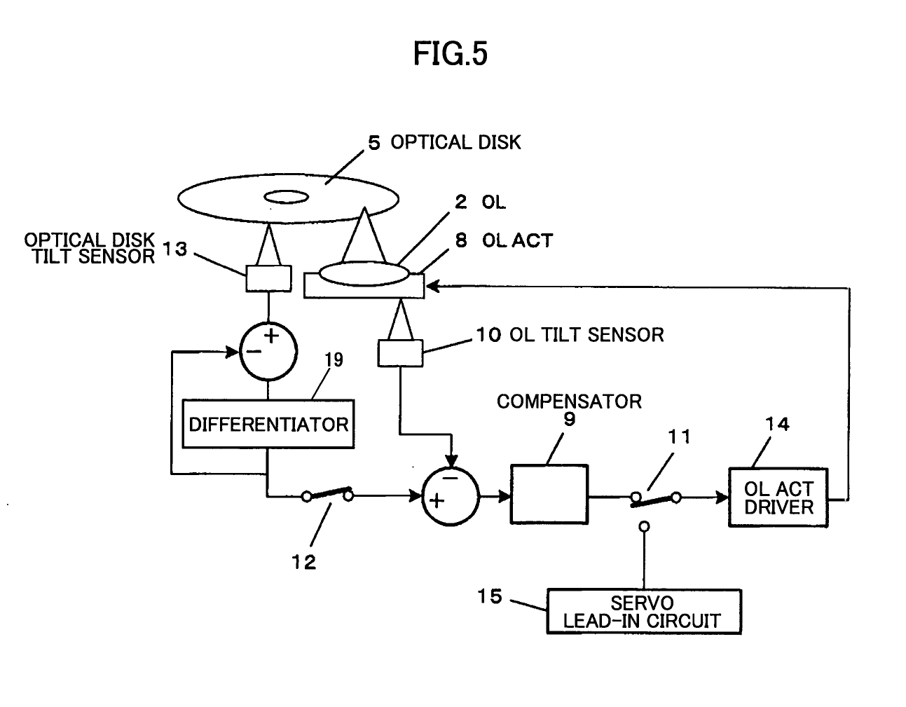

Also, in place of the offset adjuster 17, a differentiator 19′ may be employed as shown in FIG. 5, so as to form a feedback structure. The time constant of the differentiator 19′ should also be at least three times as great as one rotation cycle. More specifically, where the linear velocity is 6 m/s, one rotation cycle is 60.7 ms, with the outermost radius being 58 mm. In that case, the time constant of the differentiator 19′ is 182 ms, which is three times as great as one rotation cycle.

In this manner, the tilt control error caused due to the offset error of the optical disc tilt signal can be dramatically reduced, and an optical disc tilt compensating device with high-precision OL tilt servo can be realized.

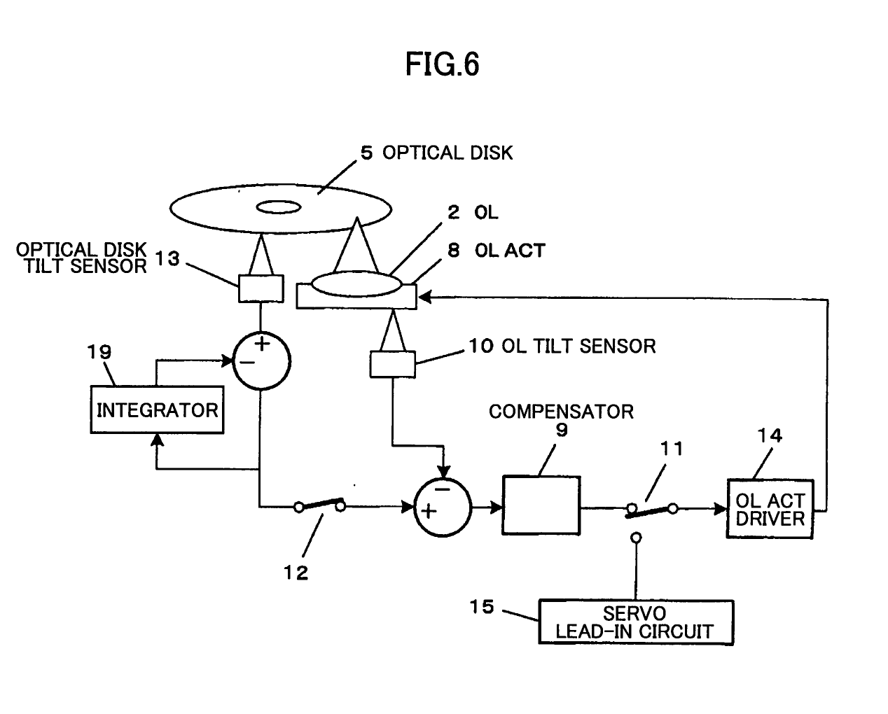

FIG. 6 is a schematic view of a tilt compensating device in accordance with a third embodiment of the present invention. In the structure shown in FIG. 6, the DC component extractor 18 shown in FIG. 3 is replaced with an integrator 19 that integrates the optical disc tilt signal and then performs negative feedback. Thus, the DC component is removed from the optical disc tilt signal.

The integration time constant of the integrator 19 is also at least three times as great as one rotation cycle. More specifically, where the linear velocity is 6 m/s, one rotation cycle is 60.7 ms, with the outermost radius being 58 mm. In that case, the integration time constant is 182 ms, which is three times as great as one rotation cycle. With the low pass filter having the time constant of 182 ms, the amplitude of one rotation cycle is −0.01 dB, and the phase difference is 3.0 deg. By performing an integration with an integration time constant greater than this cycle, the DC component in the tilt signal can be removed, without an adverse influence on the components in the optical disc tilt at higher frequencies than the rotation frequency.

In this manner, the tilt control error caused due to the offset error of the optical disc tilt signal can be dramatically reduced, and an optical disc tilt compensating device with high-precision OL tilt servo can be realized.

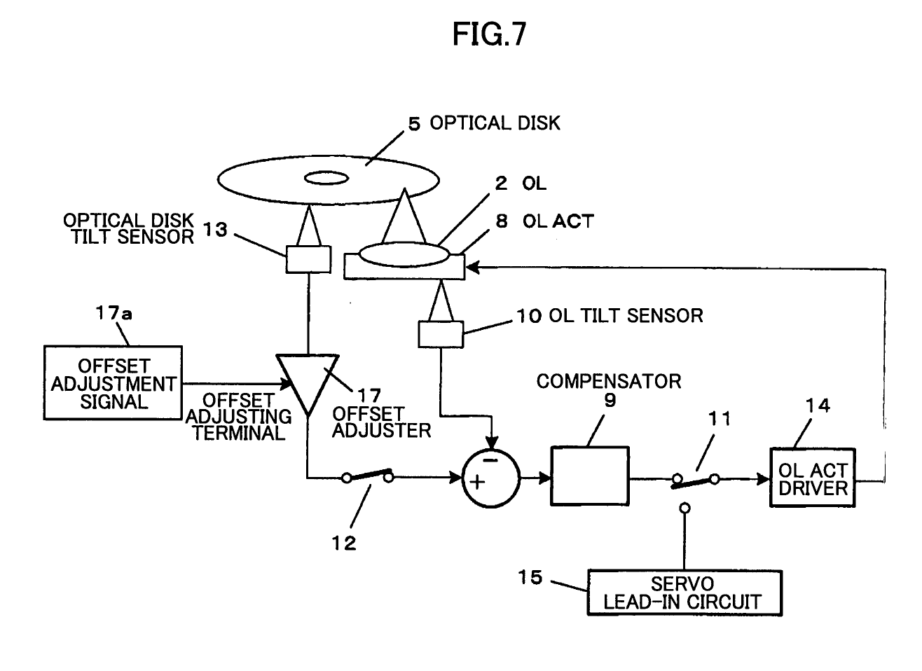

FIG. 7 is a schematic view of a tilt compensating device in accordance with a fourth embodiment of the present invention. In the optical disc tilt compensating device shown in FIG. 7, an OL tilt sensor 10 for detecting the tilt of an OL 2 is placed under the OL 2. The OL tilt sensor 10 detects the tilt of the OL 2, and converts the tilt into an electric signal. Meanwhile, an optical disc tilt sensor 13 that detects the tilt of an optical disc 5 is placed under the optical disc 5. The difference between the output signals of the two tilt sensors is input to an OLACT driver 14 via a compensator 9. The OLACT driver 14 drives an OLACT 8 in accordance with the difference signal of the two tilt sensors. An offset adjuster 17 is inserted to the output of the optical disc tilt sensor 13, and an offset adjustment signal 17a is input to the offset adjusting terminal of the offset adjuster 17, so as to adjust the offset of the optical disc tilt sensor 13.

Next, the operation of the tilt compensating device in accordance with the fourth embodiment is described. In the initial state, a first SW 11 is connected to a servo lead-in circuit 15, and a second SW 12 is turned off. When the optical disc 5 is inserted into a drive (not shown) and is rotated by a spindle motor, a signal representing the optical disc tilt is output from the optical disc tilt sensor 13. According to the above described round integration (Expression 9), the tangential tilt offset (the DC component) of the optical disc 5 is “0”. Accordingly, the signal representing the optical disc tilt offset is the tilt offset (the DC component) generated in the optical disc tilt sensor 13 and the entire tilt compensating device.

Taking the DC component in the tilt signal output from the offset adjuster 17 into consideration, the offset of the signal representing the tilt of the optical disc 5 is canceled using the signal or manually through the offset adjuster 17. The optical disc tilt signal that has been subjected to the offset adjustment represents a tilt offset of “0” in the case of a tilt sensor in the tangential direction.

At the time of a servo lead-in, the servo lead-in circuit 15 performs a servo lead-in operation. When the OL tilt is “0”, the first SW 11 is connected to the compensator 9 to form a closed loop and drive the OL tilt servo. The second SW 12 is then connected, so that the optical disc tilt signal output from the optical disc tilt sensor 13 varies with the OL tilt. The offset adjustment on the side of the OL tilt sensor 10 is performed using a detection signal such as a signal-quality evaluation signal when the RF signal becomes the greatest or “Jitter” becomes the smallest.

In the optical disc tilt compensating device of the fourth embodiment, a DC component extractor 18 that separates and extracts DC component from the optical disc tilt may be employed as in the optical disc tilt compensating device of the second embodiment shown in FIG. 3. Also, instead of the DC component extractor 18, a low pass filter may be employed as in the second embodiment. In that case, the time constant of the low pass filter should also be at least three times as great as one rotation cycle of the optical disc 5. Where r represents the radius location of the diameter of a spot formed on the optical disc 5, and v represents the linear velocity, the time constant τ of the low pass filter should satisfy the following expression:

$$τ > \frac{6 π r}{v} \qquad ( 13 )$$

Also, the time constant is set 182 ms or greater, so that the DC component in the tilt signal can be removed, without an adverse influence on the components in the optical disc tilt at higher frequencies than the rotation frequency of the optical disc 5.

In the operation of the tilt compensating device of the fourth embodiment, the first SW 11 is connected to the servo lead-in circuit 15, and the second SW 12 is turned off in the initial state, as in the second embodiment. When the optical disc 5 is inserted into a drive (not shown) and is rotated by a spindle motor, a signal representing the optical disc tilt is output from the optical disc tilt sensor 13. At the same time, a signal representing the optical disc tilt offset (the DC component) is separated and extracted from the signal representing the optical disc tilt. According to the above described round integration (Expression 9), the tangential tilt offset (the DC component) of the optical disc 5 is “0”. Accordingly, the signal representing the optical disc tilt offset is the tilt offset (the DC component) generated in the optical disc tilt sensor 13 and the entire tilt compensating device. Using the signal, the offset adjuster 17 cancels the offset of the signal representing the optical disc tilt.

More specifically, the signal representing the optical disc tilt offset is subtracted from the signal representing the optical disc tilt. In the fourth embodiment, the tilt signal output from the offset adjuster 17 is monitored, and the amount to be subtracted from the signal representing the optical disc tilt offset (the DC component) is adjusted, so that the DC component of the signal becomes “0”. In this manner, the optical disc tilt signal that has been subjected to the offset adjustment represents a tilt offset of “0” in the case of a tilt sensor in the tangential direction.

In the optical disc tilt compensating device of the fourth embodiment, the offset adjustment signal 17a shown in FIG. 7 is measured in advance, and a memory for storing the measured value is provided. For example, when the optical pickup is adjusted or a drive is installed, the optical disc tilt offset (the DC component) is measured in the assembling stage. The measured value and the preset value of the offset adjuster 17 are stored as necessary parameters for offset removal in the memory. When the drive is activated, the tilt offset is adjusted by the offset adjuster 17 in accordance with the preset values stored in the memory, and the tilt offset (the DC component) generated in the assembling stage can be canceled.

Also, an offset adjusting unit that electrically adjusts the tilt offset with respect to the tilt output from the optical disc tilt sensor 13 is constantly in the operating state while the optical disc 5 is in the drive, so that the tilt offset (the DC component) separated and extracted from the optical disc tilt by the DC component extractor 18 becomes “0”. Accordingly, immediately after the optical disc 5 is inserted into the drive, the tilt of the optical disc 5 can be detected, and tilt servo is driven so that the OL tilt varies with the optical disc tilt. By doing so, when the OL tilt servo is driven, servo can be driven for all the four axes to continuously perform focus lead-in and tracking.

In this manner, the tilt control error caused due to the offset error of the optical disc tilt signal can be dramatically reduced, and an optical disc tilt compensating device with high-precision OL tilt servo can be realized.

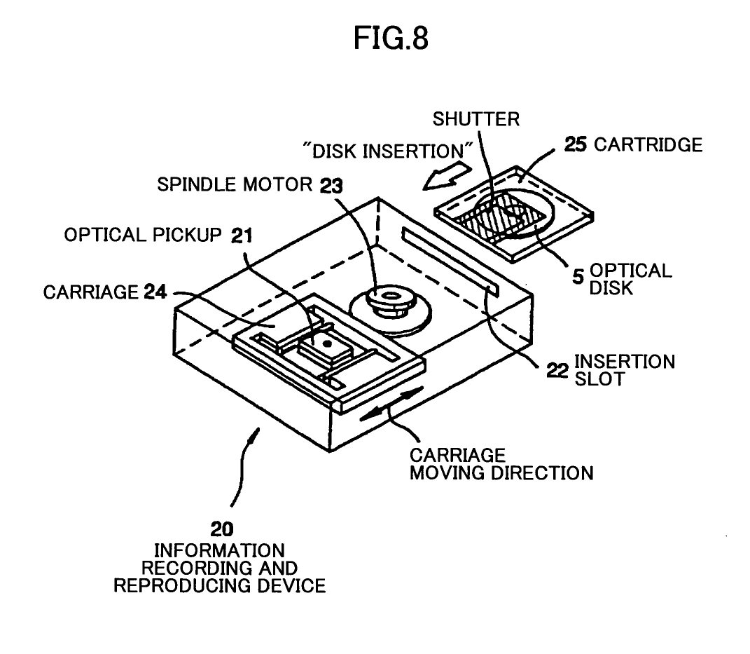

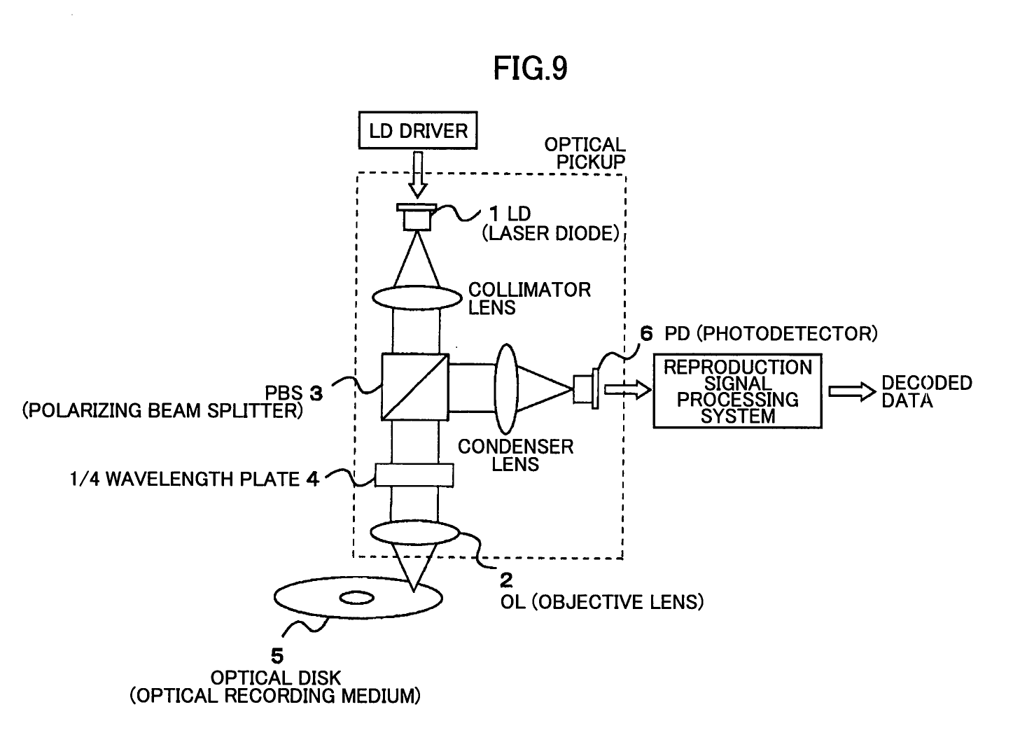

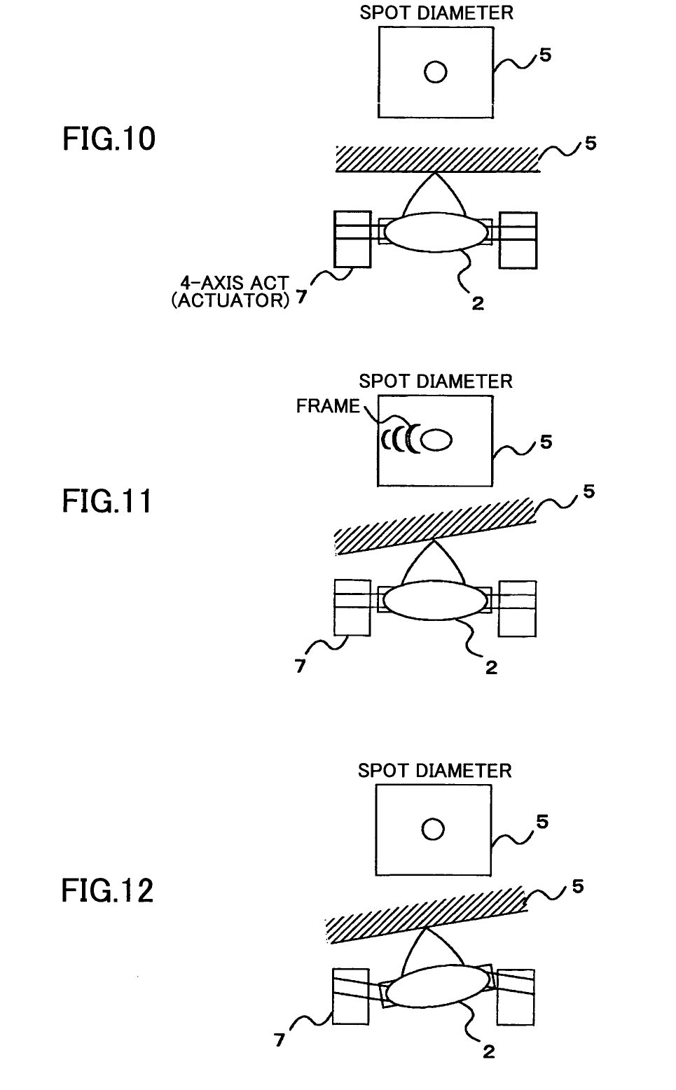

FIG. 8 is a schematic perspective view of an information recording and reproducing device that is an optical recording device as well as an optical reproducing device in accordance with a fifth embodiment of the present invention. As shown in FIG. 8, the information recording and reproducing device 20 performs at least one of recording, reproducing, and erasing of information, using an optical pickup 21 on the optical disc 5. In the fifth embodiment, the optical disc 5 is housed in a cartridge 25 that serves as a protection casing. The cartridge 25 containing the optical disc 5 is inserted into the information recording and reproducing device 20 from an insertion slot 22. The direction of “disc insertion” is indicated by an arrow in FIG. 8. The optical disc 5 is then rotated by a spindle motor 23, and the optical pickup 21 performs recording, reproducing, or erasing of information. The optical disc 5 is not necessarily housed in the cartridge 25, and may be used as it is.

The information recording and reproducing device 20 of the fifth embodiment includes the optical disc tilt compensating device of any of the first through fourth embodiments. In the information recording and reproducing device 20, light emitted from the light source is concentrated upon the recording surface of the optical disc 5, and information recording or erasing is then performed. Transmission light or reflected light from the optical disc 5 is detected by a photodetector, or light condensed in the signal detecting optical system is detected by the photodetector, so as to reproduce information. With the tilt compensating device of any of the foregoing embodiments, frame aberrations are minimized, and a high-quality beam spot can be formed on the optical disc. As a result, an optical pickup with less read errors and higher writing quality can be obtained. In accordance with this embodiment, an information recording and reproducing device that is equipped with such an optical pickup can be realized.

As described so far, with the optical recording medium tilt compensating device, the tilt compensating method, the optical recording device, and the optical reproducing device in accordance with the present invention, the tilt control error caused due to the offset error in the optical disc tilt is reduced, and an optical disc tilt compensating device and method with an OL tilt servo can be realized. Also, frame aberrations can be minimized, and a high-quality beam spot can be formed on the optical disc. Tilt servo control can be performed on an optical disc recording and reproducing device with less read errors and higher writing quality. A device and method for correcting a tilt error through the tilt servo control are realized, and an optical recording device and an optical reproducing device that employ the device and method are also realized.

It should be noted that the present invention is not limited to the embodiments specifically disclosed above, but other variations and modifications may be made without departing from the scope of the present invention.

This patent application is based on Japanese Priority Patent Application Nos. 2004-041310, filed on Feb. 18, 2004, and 2004-305422, filed on Oct. 20, 2004, the entire contents of which are hereby incorporated by reference.

1. An optical recording medium tilt compensating device, comprising:
an objective lens that concentrates light onto a recording surface of an optical recording medium, the light being emitted from a light source;
an optical recording medium tilt offset detecting unit that detects a direct current component from a change with time in an optical recording medium tilt caused when the optical recording medium is rotated; and
a tilt actuator that controls a tilt of the objective lens by adjusting a relative tilt between the objective lens and the optical recording medium based on the direct current component detected by the optical recording medium tilt offset detecting unit, the relative tilt being obtained from an optical recording medium tilt sensor of an optical pickup that detects the tilt of the optical recording medium.

2. An optical recording medium tilt compensating device, comprising:
an objective lens that concentrates light onto a recording surface of an optical recording medium, the light being emitted from a light source;
an objective lens tilt sensor that detects a tilt of the objective lens;
an optical recording medium tilt sensor that detects a tilt of the optical recording medium;
a relative tilt detecting unit that detects a relative tilt between the objective lens and the optical recording medium from the tilts detected by the objective lens tilt sensor and the optical recording medium tilt sensor;
an optical recording medium tilt offset detecting unit that detects a direct current component from a change with time in the tilt of the optical recording medium, the change with time being caused when the optical recording medium is rotated; and
an objective lens tilt actuator that controls the tilt of the objective lens by adjusting the relative tilt based on the direct current component detected by the optical recording medium tilt offset detecting unit.

3. An optical recording medium tilt compensating device, comprising:
an objective lens that concentrates light onto a recording surface of an optical recording medium, the light being emitted from a light source;
an objective lens tilt actuator that controls a tilt of the objective lens;
an objective lens tilt sensor that detects the tilt of the objective lens;
an optical recording medium tilt sensor that detects a tilt of the optical recording medium;
an arithmetic operation unit that calculates a relative tilt between the objective lens and the optical recording medium from the tilt detected by the objective lens tilt sensor and the tilt detected by the optical recording medium tilt sensor;
a control unit that controls the tilt of the objective lens in such a manner that the aberration of the diameter of a spot formed by concentrating the light onto the recording surface of the optical recording medium is minimized, the control being performed by driving the objective lens tilt actuator, based on the relative tilt output from the arithmetic operation unit; and
an optical recording medium tilt offset detecting unit that detects a direct current component from a change with time in the tilt of the optical recording medium, the change with time being caused when the optical recording medium is rotated,
the relative tilt being adjusted based on the detected direct current component.

4. An optical recording medium tilt compensating device, comprising:
an objective lens that concentrates light onto a recording surface of an optical recording medium, the light being emitted from a light source;
an objective lens tilt actuator that controls a tilt of the objective lens;
an objective lens tilt sensor that detects the tilt of the objective lens;
an optical recording medium tilt sensor that detects a tilt of the optical recording medium;
an arithmetic operation unit that calculates a relative tilt between the objective lens and the optical recording medium from the tilt detected by the objective lens tilt sensor and the tilt detected by the optical recording medium tilt sensor;
a control unit that controls the tilt of the objective lens in such a manner that the aberration of the diameter of a spot formed by concentrating the light onto the recording surface of the optical recording medium is minimized, the control being performed by driving the objective lens tilt actuator, based on the relative tilt output from the arithmetic operation unit; and
an extracting unit that separates and extracts a direct current component from the tilt of the optical recording medium, based on a change with time in the tilt of the optical recording medium that is output from the optical recording medium tilt sensor, the change with time being caused when the optical recording medium is rotated,
the relative tilt being adjusted based on the separated and extracted direct current component.

5. The optical recording medium tilt compensating device as claimed in claim 4, wherein the extracting unit that separates and extracts the direct current component from the tilt of the optical recording medium is an integrator that integrates the output signal from the optical recording medium tilt sensor in accordance with the rotation cycles of the optical recording medium.

6. The optical recording medium tilt compensating device as claimed in claim 5, wherein the integrator has an integration time constant that is log (1−P) times as great as one rotation cycle of the optical recording medium, with P representing the reliability of the output signal.

7. The optical recording medium tilt compensating device as claimed in claim 5, wherein the integrator has an integration time constant that is equivalent to three rotation cycles of the optical recording medium.

8. The optical recording medium tilt compensating device as claimed in claim 4, wherein the extracting unit that separates and extracts the direct current component from the tilt of the optical recording medium is a low pass filter that is inserted in a stage after the signal output terminal of the optical recording medium tilt sensor.

9. An optical recording medium tilt compensating device, comprising:
an objective lens that concentrates light onto a recording surface of an optical recording medium, the light being emitted from a light source;
an objective lens tilt actuator that controls a tilt of the objective lens;
an objective lens tilt sensor that detects the tilt of the objective lens;
an optical recording medium tilt sensor that detects a tilt of the optical recording medium;
an arithmetic operation unit that calculates a relative tilt between the objective lens and the optical recording medium from the tilt detected by the objective lens tilt sensor and the tilt detected by the optical recording medium tilt sensor;
a control unit that controls the tilt of the objective lens in such a manner that the aberration of the diameter of a spot formed by concentrating the light onto the recording surface of the optical recording medium is minimized, the control being performed by driving the objective lens tilt actuator, based on the relative tilt output from the arithmetic operation unit; and
an offset adjusting unit that electrically adjusts a direct current component in the tilt output from the optical recording medium tilt sensor.

10. The optical recording medium tilt compensating device as claimed in claim 9, further comprising:
an extracting unit that separates and extracts the direct current component from the tilt of the optical recording medium that is output from the optical recording medium tilt sensor, based on a change with time in the tilt of the optical recording medium, the change with time being caused when the optical recording medium is rotated.

11. The optical recording medium tilt compensating device as claimed in claim 9, wherein a low pass filter is inserted in a stage before the offset adjusting unit that electrically adjusts the direct current component in the tilt that is output from the optical recording medium tilt sensor.

12. The optical recording medium tilt compensating device as claimed in claim 8, wherein the low pass filter has a time constant that is log (1−P) times as great as one rotation cycle of the optical recording medium, with P representing the reliability of the output signal.

13. The optical recording medium tilt compensating device as claimed in claim 8, wherein the low pass filter has a time constant that is equivalent to three rotation cycles of the optical recording medium.

14. The optical recording medium tilt compensating device as claimed in claim 8, wherein the low pass filter has a time constant τ that satisfies the following condition:
$$τ > \frac{6 π r}{v} \qquad ( 1 )$$
where r represents the radius location of the diameter of the spot formed on the optical recording medium, and v represents the linear velocity.

15. The optical recording medium tilt compensating device as claimed in claim 8, wherein the time constant of the low pass filter is 182 ms.

16. The optical recording medium tilt compensating device as claimed in claim 9, wherein the offset adjusting unit electrically adjusts the direct current component in a signal representing the tilt output from the optical recording medium tilt sensor, and outputs the signal representing the optical recording medium tilt with the direct current component of “0”.

17. The optical recording medium tilt compensating device as claimed in claim 10, further comprising:
a storage unit that stores the value of the direct current component separated and extracted from the optical recording medium tilt by the direct current component separating and extracting unit, when an optical pickup or a drive is installed.

18. The optical recording medium tilt compensating device as claimed in claim 16, wherein the offset adjusting unit that electrically adjusts the direct current component in the signal representing the tilt output from the optical recording medium tilt sensor is constantly in the electrically adjusting state while the optical recording medium is in a drive, so that the direct current component of the optical recording tilt to be output from the offset adjusting unit becomes “0”.

19. An optical recording medium tilt compensating method, comprising the steps of:
detecting a tilt of an optical recording medium by an optical recording medium tilt sensor;
detecting a direct current component of the optical recording medium tilt that is caused when the optical recording medium is rotated;
calculating a relative tilt from an objective lens tilt detected by an objective lens tilt sensor and the optical recording medium tilt, using an arithmetic operation unit; and
controlling the tilt of the objective lens by adjusting the relative tilt based on the detected direct current component.

20. The optical recording medium tilt compensating method as claimed in claim 19, wherein the direct current component of the optical recording medium tilt that is caused by the rotation of the optical recording medium is separated and extracted by an integrator that integrates the tilt output from the optical recording medium tilt sensor in accordance with rotation cycles of the optical recording medium.

21. The optical recording medium tilt compensating method as claimed in claim 20, wherein the integrator integrates the output signal from the optical recording medium tilt sensor, using an integration time constant that is log (1−P) times as great as one rotation cycle of the optical recording medium, with P representing the reliability of the output signal.

22. The optical recording medium tilt compensating method as claimed in claim 20, wherein the integrator integrates the output signal from the optical recording medium tilt sensor, using an integration time constant that is equivalent to three rotation cycles of the optical recording medium.

23. The optical recording medium tilt compensating method as claimed in claim 19, wherein the direct current component of the optical recording medium tilt that is caused by the rotation of the optical recording medium is separated and extracted by a low pass filter that is inserted in a stage after the signal output terminal of the optical recording medium tilt sensor.

24. The optical recording medium tilt compensating method as claimed in claim 23, wherein the low pass filter separates and extracts the direct current component of the output signal from the optical recording medium tilt sensor, using a time constant that is log (1−P) as great as one rotation cycle of the optical recording medium, with P representing the reliability of the output signal.

25. The optical recording medium tilt compensating method as claimed in claim 23, wherein the low pass filter separates and extracts the direct current component of the output signal from the optical recording medium tilt sensor, using a time constant that is equivalent to three rotation cycles of the optical recording medium.

26. The optical recording medium tilt compensating method as claimed in claim 23, wherein the low pass filter separates and extracts the direct current component of the output signal from the optical recording medium tilt sensor, using a time constant τ that satisfies the following condition:
$$τ > \frac{6 π r}{v} \qquad ( 2 )$$
where r represents the radius location of the diameter of the spot formed on the optical recording medium, and v represents the linear velocity.

27. The optical recording medium tilt compensating method as claimed in claim 23, wherein the low pass filter separates and extracts the direct current component of the output signal from the optical recording medium tilt sensor, using a time constant of 182 ms.

28. The optical recording medium tilt compensating method as claimed in claim 19, wherein the electric adjustment is performed using the direct current component, so that the direct current component of the optical recording medium tilt caused by the rotation of the optical recording medium becomes “0”.

29. The optical recording medium tilt compensating method as claimed in claim 19, wherein the direct current component of the optical recording medium tilt caused by the rotation of the optical recording medium is separated and extracted when an optical pickup or a drive is installed, and the value of the direct current component is stored in a storage unit.

30. The optical recording medium tilt compensating method as claimed in claim 28, wherein the adjustment to be performed using the direct current component in such a manner that the direct current component of the optical recording medium tilt becomes “0” is constantly performed while the optical recording medium is in a drive.

31. An optical recording device comprising:
an optical recording medium tilt compensating device that comprises:
an objective lens that concentrates light onto a recording surface of an optical recording medium, the light being emitted from a light source;
an optical recording medium tilt offset detecting unit that detects a direct current component from a change with time in an optical recording medium tilt caused when the optical recording medium is rotated; and
a tilt actuator that controls a tilt of the objective lens by adjusting a relative tilt between the objective lens and the optical recording medium based on the direct current component detected by the optical recording medium tilt offset detecting unit, the relative tilt being obtained from an optical recording medium tilt sensor of an optical pickup that detects the tilt of the optical recording medium,
wherein the optical recording device adjusts a direct current component of the optical recording medium tilt, and performs information recording or erasing by concentrating the light onto the recording surface of the optical recording medium.

32. An optical recording device that adjusts a direct current component of a tilt of an optical recording medium, and performs information recording or erasing by concentrating light onto a recording surface of the optical recording medium, the light being emitted from a light source,
the optical recording device utilizing an optical recording medium tilt compensating method comprising the steps of:
detecting a tilt of an optical recording medium by an optical recording medium tilt sensor;
detecting a direct current component of the optical recording medium tilt that is caused when the optical recording medium is rotated;
calculating a relative tilt from an objective lens tilt detected by an objective lens tilt sensor and the optical recording medium tilt, using an arithmetic operation unit; and
controlling the tilt of the objective lens by adjusting the relative tilt based on the detected direct current component.

33. An optical reproducing device comprising:
an optical recording medium tilt compensating device that comprises:
an objective lens that concentrates light onto a recording surface of an optical recording medium, the light being emitted from a light source;
an optical recording medium tilt offset detecting unit that detects a direct current component from a change with time in an optical recording medium tilt caused when the optical recording medium is rotated; and
a tilt actuator that controls a tilt of the objective lens by adjusting a relative tilt between the objective lens and the optical recording medium based on the direct current component detected by the optical recording medium tilt offset detecting unit, the relative tilt being obtained from an optical recording medium tilt sensor of an optical pickup that detects the tilt of the optical recording medium,
wherein the optical reproducing device adjusts a direct current component of the optical recording medium tilt, and performs information reproduction by detecting transmission light or reflected light from the optical recording medium with a photodetector, or detecting the light concentrated in the signal detecting optical system, after concentrating the light onto the recording surface of the optical recording medium.

34. An optical reproducing device that adjusts a direct current component of a tilt of an optical recording medium, and performs information reproduction by detecting transmission light or reflected light from the optical recording medium with a photodetector, or detecting light concentrated in the signal detecting optical system, after concentrating the light onto a recording surface of the optical recording medium, the light being emitted from a light source,
the optical reproducing device utilizing an optical recording medium tilt compensating method comprising the steps of:
detecting a tilt of an optical recording medium by an optical recording medium tilt sensor;
detecting a direct current component of the optical recording medium tilt that is caused when the optical recording medium is rotated;
calculating a relative tilt from an objective lens tilt detected by an objective lens tilt sensor and the optical recording medium tilt, using an arithmetic operation unit; and
controlling the tilt of the objective lens by adjusting the relative tilt based on the detected direct current component.
